(19) United States
(12) Patent Application Publication
(10) Pub. No.: US 2004/0075675 A1
(43) Pub. Date: Apr. 22, 2004

(54) Apparatus and method for accessing services via a mobile terminal

(76) Inventors: Tommi Raivisto, Vantaa (FI); Frank Dawson, Southlake, TX (US); Sakari Kotola, Kauniainen (FI)

Correspondence Address: CRAWFORD PLLC, Suite 390, 1270 Northland Drive, St. Paul, MN, 55120, US

(21) Appl. No.: 10/273,397

(22) Filed: Oct. 17, 2002

(51) Int. Cl. G09G 5/00

(52) U.S. Cl. 345/700

(57) ABSTRACT

A system, apparatus and method to allow provisioning of services and execution of those services at the mobile terminal. Services may be locally, remotely or manually provisioned within a mobile terminal and may be viewed by an end user of the mobile terminal after being filtered by context. The filtered list of services being accessible from a service panel of the mobile terminal, whereby the mere selection of the service allows execution of the service at the mobile terminal using the appropriate underlying communication technology with no further interaction required from the end user.

### FIELD OF THE INVENTION

This invention relates in general to mobile communications, and more particularly to a system, method and apparatus for locating services and applications via mobile terminals using a service panel contained within the mobile terminal.

### BACKGROUND OF THE INVENTION

Mobile telecommunications has seen an explosive growth within just the last decade and is expected to continue this growth trend into the future. Whereas mobile communications began in its infancy stages as primarily providing voice only communications, today's mobile communications has by necessity grown in complexity and capacity to accommodate the increasingly demanding requirements of not only voice transfer, but also data transfer in its many forms, such as messaging and browsing.

As the telecommunications industry develops technology to keep pace with the ever increasing demands of its users, a hybridization of the mobile subscriber's interface to the mobile communications network is taking place. The mobile terminal is transforming from a handheld communications device into a data portal used to penetrate the plethora of services and applications that were previously only available to users stationed at land-based, computing terminals having direct connectivity to the Internet. The mobile communications portal is, therefore, taking on many of the land-based computing terminal's characteristics to allow the facilitation of user interactions within the mobile communications environment.

Today's mobile communication terminals, for example, provide the user with menu driven options that are selectable by the user from a text-based or graphical display. As the number of options, services and applications made available to the mobile user increases, traversal of the menu becomes increasingly perplexing and unmanageable. Menu options offered on the mobile communication terminals not only provide access to databases located within the mobile terminal itself, e.g., directory listings, “to do” lists, calendars, etc., but also provide the electronic conduit required to access services and applications located within the communications infrastructure.

While access to the plethora of services and applications is exciting to the mobile world, locating the desired information and utilizing the various access methods can become burdensome to the casual mobile terminal user. In fact, current mobile data services have taken off relatively slowly, partly due to the inconvenient and complex service discovery solutions offered for users of existing mobile phones. In addition, the way that mobile users have been able to access the available services and applications and/or how those services and applications are provisioned to the end user terminals is somewhat limited to specific technologies and implementations.

Current mobile data service discovery and initiation has been accomplished in a variety of ways. Browsing using the Wireless Application Protocol (WAP) generally involves starting from an operator preset service portal, and browsing forward by clicking various menus. Other current mobile data service discovery includes searching for the information required by sending messages, such as Short Message Service (SMS) messages, from various sources such as advertisements. For example, users may be required to search advertisements to find content strings and application numbers. Another existing service discovery method involves mobile terminal configuration settings. Currently, this is often performed by initiating the configuration from a web site or requesting it personally through the use of a Subscriber Identity Module (SIM).

The manner in which end users locate the various services available via a mobile communications network, and/or the manner in which these services are provisioned to end user terminals, has traditionally been specific to certain technologies. Current services are generally “distributed” or “hidden” behind several types of applications dedicated to certain access mechanisms, such as SMS client, WAP browser, MMS client, Java Virtual Machine, etc. This has resulted in a fragmented market, slowing down the adoption and development of these services, ultimately inhibiting the ability of service providers to market their services to the end mobile users. This fragmented approach also makes service discovery and access difficult for the user. In addition, context-sensitive services, such as those dependent upon a mobile user's location, time, profile, etc. tend to make service discovery by the end user more difficult.

Accordingly, there is a need in the communications industry for a manner of reducing the mobile terminal users' burden of discovering and initiating mobile data services. A need exists to reduce the burden on users of sifting through numerous network sites, advertisements, documents, etc. to locate services and information when the user is in a situation/location where there is a high probability that the user will want a certain type of information, and to reduce user burden in manipulating the mobile terminal to invoke the proper access methodology. Still further, there is a need to allow the service providers and operators to facilitate the offering of their services and applications to end users, so that the end user is presented with a single, uniform view of the available network services and resident applications available while maintaining a relative insulation to context sensitivities. The present invention fulfills these and other needs, and offers other advantages over the prior art.

### SUMMARY OF THE INVENTION

The present invention is directed to a system, apparatus, and method for locating available information and services/applications via mobile terminals through the use of a service panel that is operable via the mobile terminal.

In accordance with one embodiment of the invention, a method is provided for accessing network services and other applications on a mobile terminal. The method includes collectively presenting selectable service items, such as icons or other indicia, by the mobile terminal. Each of the selectable service items corresponds to a network service. Selection of at least one of the service items is facilitated via the mobile terminal. At least one of the plurality of access applications associated with a selected service item is activated, and the network service associated with the selected service item is invoked using the activated access application.

In accordance with another embodiment of the invention, a method is provided for locating services offered by a data network from a mobile terminal. The method comprises provisioning services onto the mobile terminal, activating a service panel to display the provisioned services, filtering the provisioned services prior to display so that context sensitive services are displayed by the mobile terminal, and activating the context sensitive service by selecting one of the filtered provisioned services from the service panel.

In accordance with another embodiment of the invention, a method is provided for facilitating service execution by mobile terminals. The method comprises allocating a list of predetermined services to the mobile terminal, filtering the predetermined list of services in response to a context of the mobile terminal, activating a service panel to allow selection from the filtered list of predetermined services, and launching the selected service by simply selecting from one of the services displayed by the service panel.

In accordance with another embodiment of the invention, a mobile terminal is provided. The mobile terminal comprises a provisioning means for receiving a list of services available to the mobile terminal, a storage means to store content associated with the services, a filter means coupled to the storage means to limit the list of services based on a context, and a service panel means coupled to the filter means to display the services based on the context.

In accordance with another embodiment of the invention, a system for facilitating service provisioning by mobile terminals is provided. The system comprises at least one provisioning device used to provide a list of services, and a mobile terminal coupled to the at least one provisioning device. The mobile terminal comprises a provisioning means for receiving a list of services available to the mobile terminal from the at least one provisioning device a storage means to store content associated with the services, a filter means coupled to the storage means to limit the list of services based on a context, and a service panel means coupled to the filter means to display the services based on the context.

The above summary of the present invention is not intended to describe each illustrated embodiment or implementation of the present invention. This is the purpose of the figures and the associated discussion which follows.

BRIEF DESCRIPTION OF THE DRAWINGS

The invention is described in connection with the embodiments illustrated in the following diagrams.

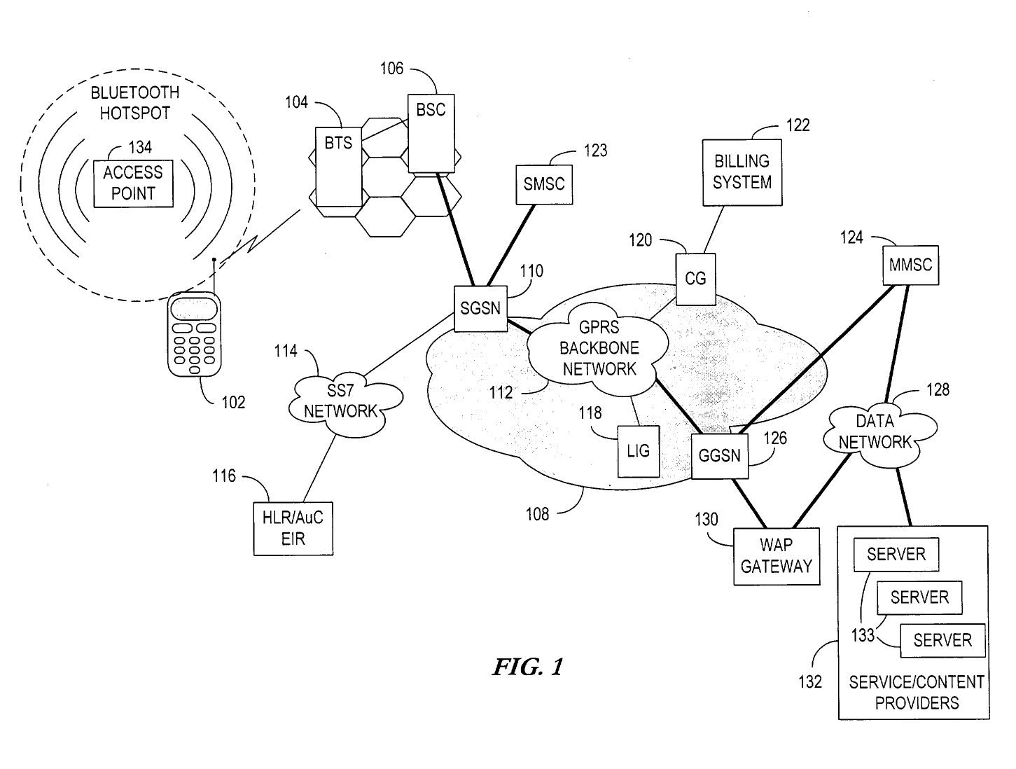

FIG. 1 is a block diagram illustrating an exemplary embodiment of a representative mobile communications network in which the principles of the present invention may be employed;

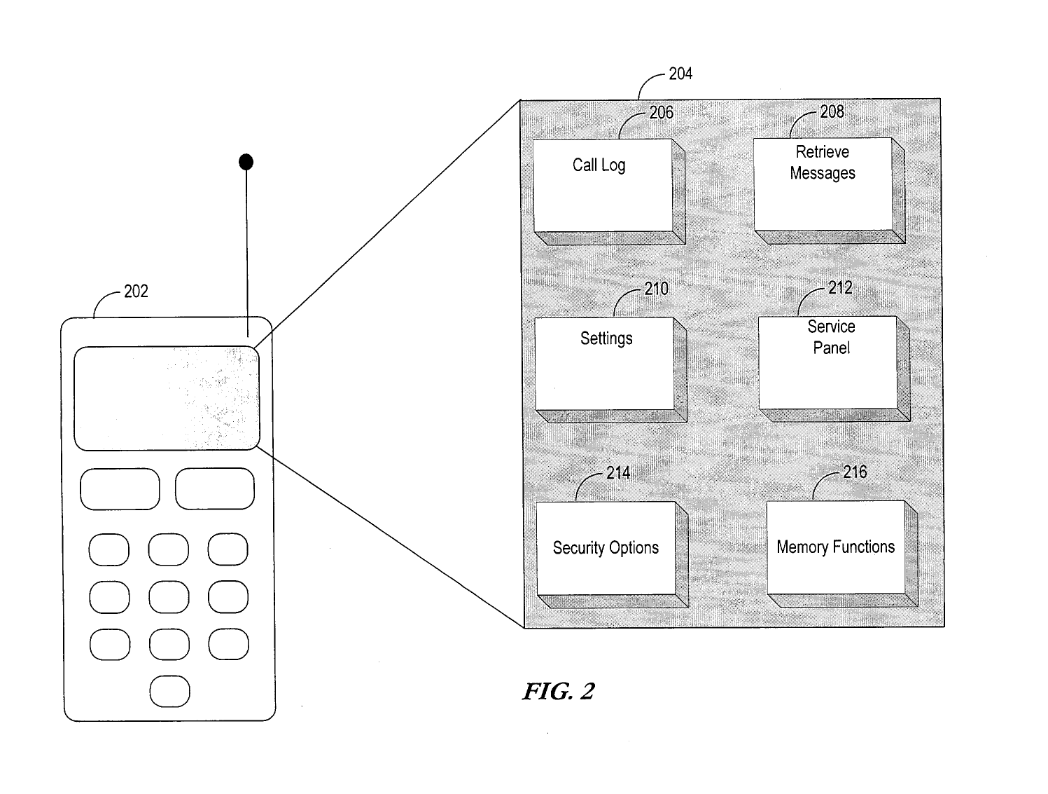

FIG. 2 illustrates a graphical user interface of a mobile terminal;

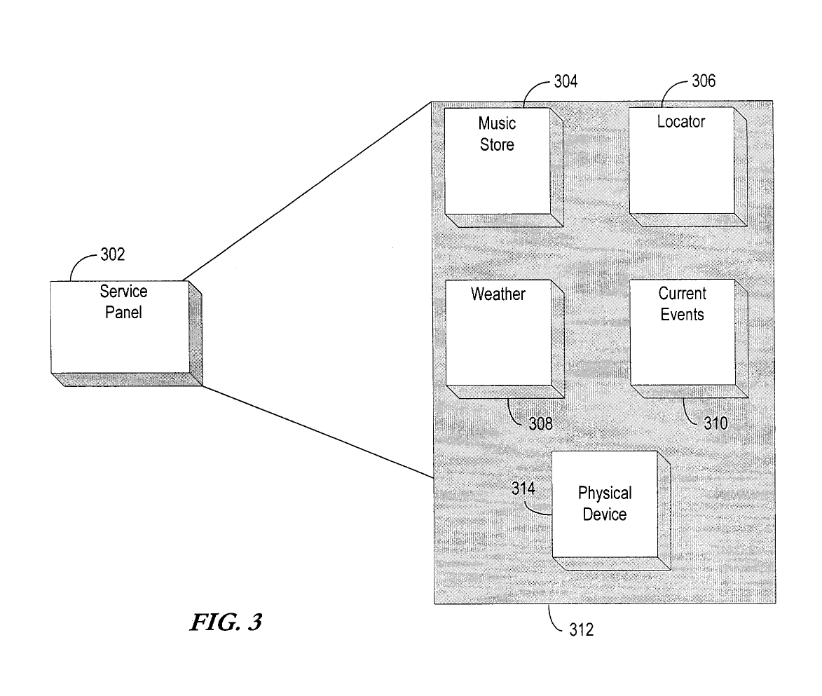

FIG. 3 illustrates a graphical user interface of a service panel;

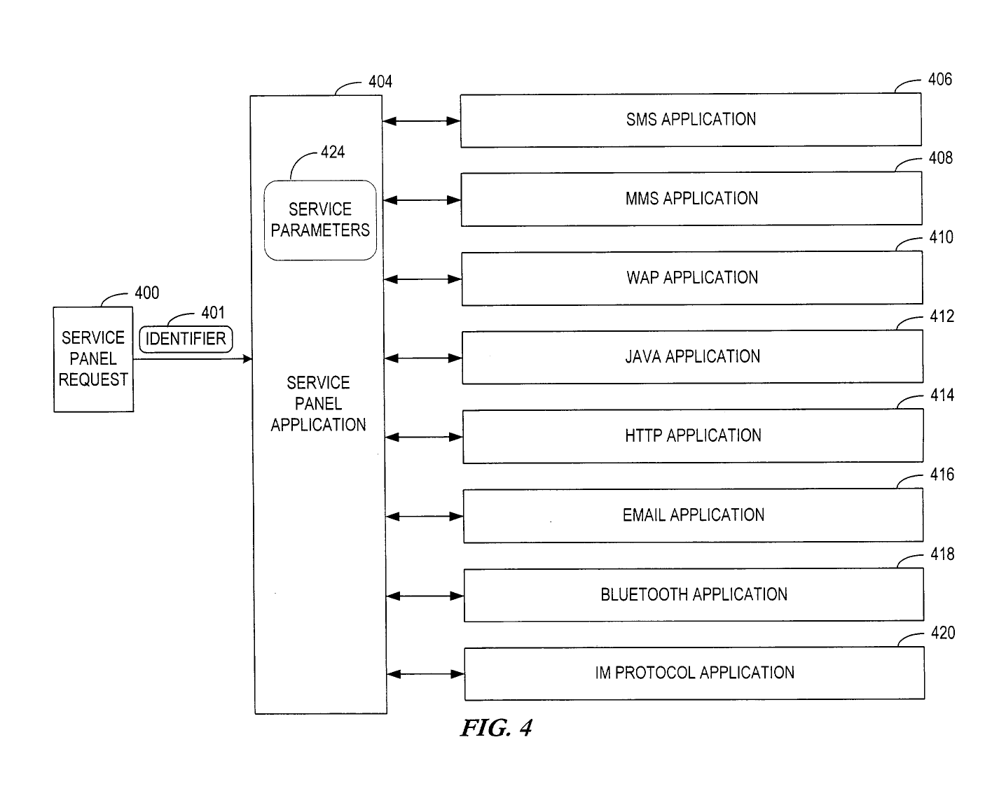

FIG. 4 illustrates a block diagram of a system used to initiate a content download request for a network service according to the present invention;

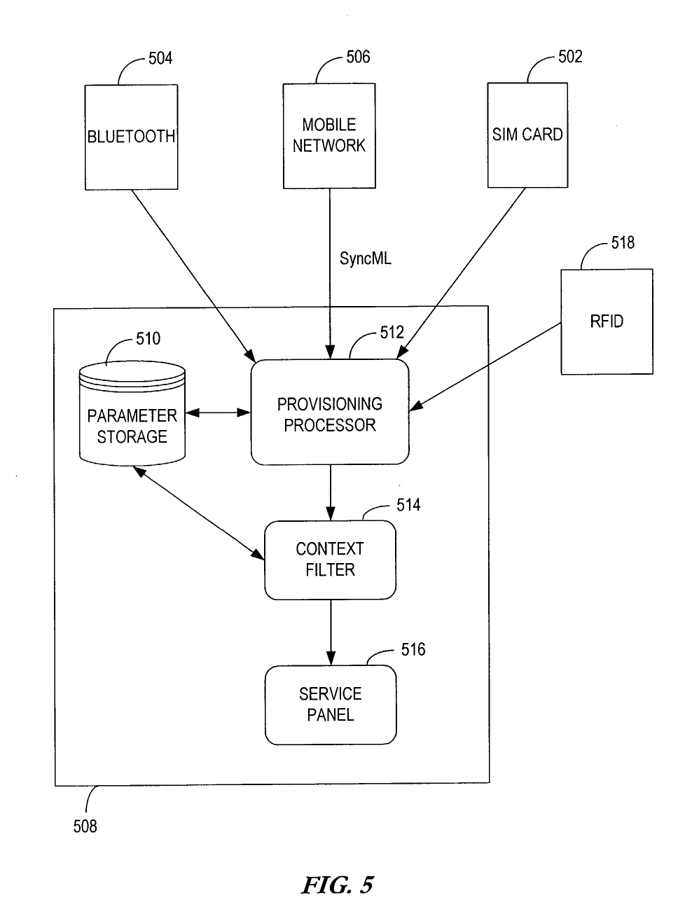

FIG. 5 illustrates a block diagram of a systems used to provision services into a mobile terminal according to the present invention;

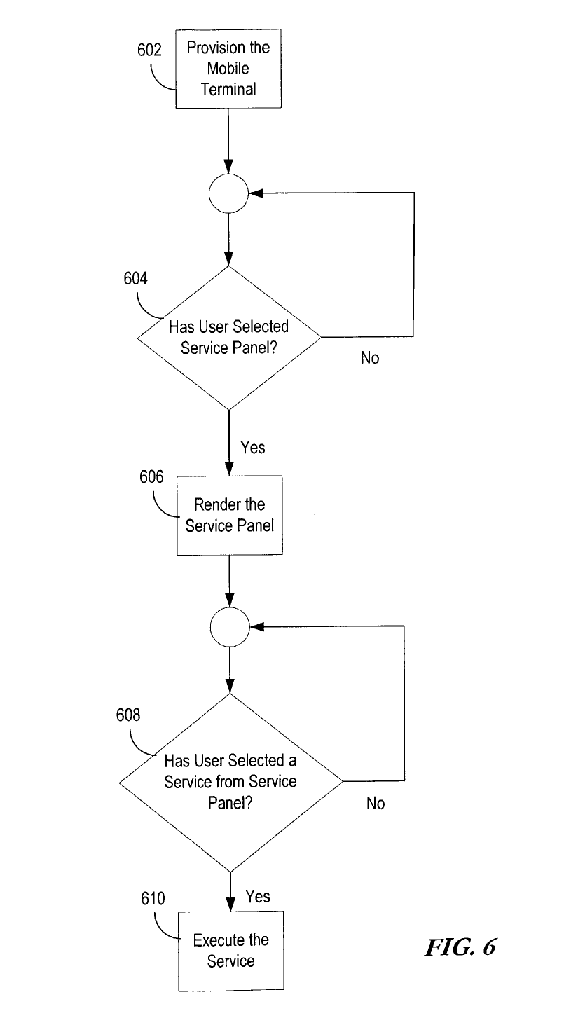

FIG. 6 illustrates a flow diagram of the operation of a mobile terminal having a service panel according to the present invention; and

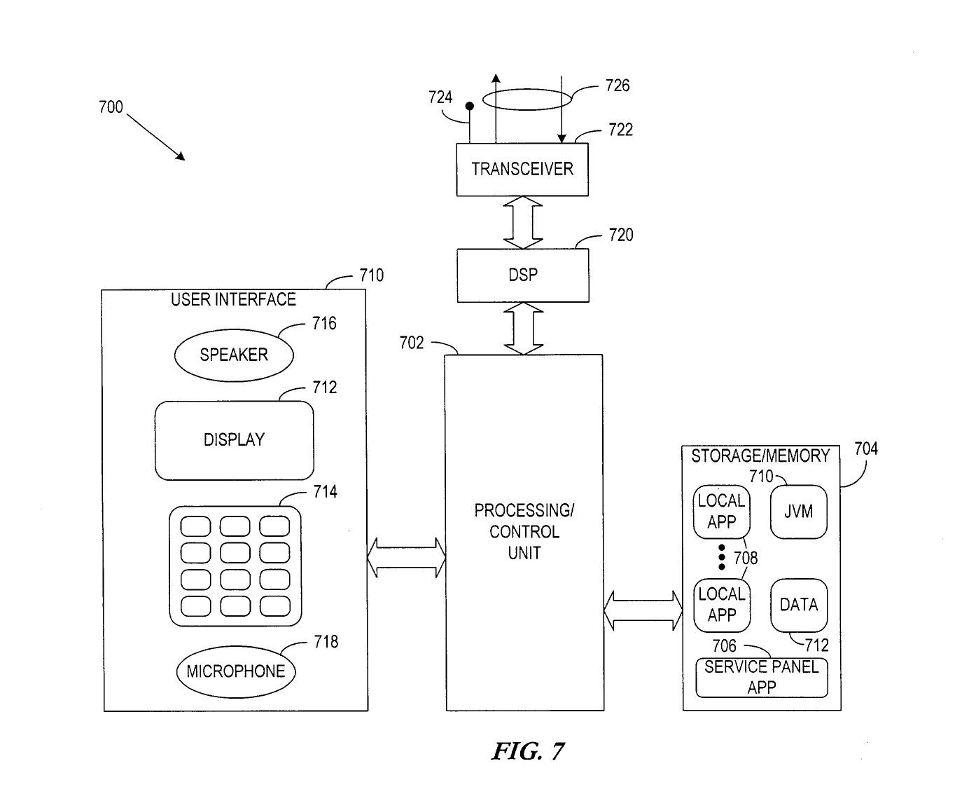

FIG. 7 illustrates a representative mobile terminal computing system capable of carrying out operations in accordance with the invention.

### DETAILED DESCRIPTION OF THE INVENTION

In the following description of the exemplary embodiment, reference is made to the accompanying drawings which form a part hereof, and in which is shown by way of illustration the specific embodiment in which the invention may be practiced. It is to be understood that other embodiments may be utilized, as structural and operational changes may be made without departing from the scope of the present invention.

Generally, the present invention provides an apparatus, system, and method for organizing and invoking available services and applications via mobile terminals by an end user. The present invention also facilitates service discovery and provisioning the services to the mobile terminal. A mobile device/terminal is equipped with a service panel, which may be scaleable across all types of user interfaces to include small text-based displays to larger, color displays having graphical images selectable with a pointing device. When a service is activated via the service panel, a number of actions may be initiated, such as starting an application or initiating a content download request over any number of protocols including SMS (Short Messaging Service), WAP (Wireless Application Protocol), HTTP (HyperText Transport Protocol), MMS (Multimedia Messaging Service), Email, Bluetooth or IM (Instant Messaging) protocols, to name only a few. In one embodiment of the invention, the service panel provides a graphical user interface allowing the end user to select from various services that are represented by icons, text, images, or other visual indicia. The service panel thus facilitates service initiation and execution by the end user through selection of the desired service. The service panel in accordance with the present invention allows the user to have one uniform, technology-independent, and context sensitive view to available services, while allowing service providers to have one uniform manner to provision (i.e., make services available) for end users. The present invention is scalable across different terminal user interface categories, across different service technologies, and across both local bearer technologies (e.g., Bluetooth) and remote bearer technologies (e.g., cellular network).

FIG. 1 is a block diagram illustrating an exemplary embodiment of a representative mobile communications network in which the principles of the present invention may be employed. The present invention relates to service initiation, execution, and provisioning in wireless environments. For example, services may be provisioned to the service panel through a variety of interfaces, such as SMS, MMS, Bluetooth etc. The service panel may then launch a browser for those services or applications that are based on the Uniform Resource Locater (URL), a Java application for Java-based applications, an SMS application for SMS communication, and so forth. Therefore, FIG. 1 is provided to illustrate a number of representative technologies associated with mobile networking in which service providers, network operators and the like may utilize to provide their services and/or to provision these services to end user terminals. A variety of different and/or additional mobile communications technologies exist, and the example of FIG. 1 is provided for purposes of illustration.

For purposes of illustration and not of limitation, FIG. 1 is described in the context of Global System for Mobile Communications (GSM) network in which General Packet Radio System (GPRS) service, SMS, MMS, and other services may be implemented. GPRS is a packet-switched service for GSM that mirrors the Internet model and enables seamless transition towards 3G (third generation) networks. GPRS thus provides actual packet radio access for mobile GSM and time-division multiple access (TDMA) users, and is ideal for Wireless Application Protocol (WAP) services. While the exemplary embodiment of FIG. 1 is generally described in connection with GPRS, and GSM which is the underlying digital technology of GPRS, it should be recognized that the specific references to GSM and GPRS are provided to facilitate an understanding of the invention. As will be readily apparent to those skilled in the art from the description provided herein, the invention is equally applicable to other mobile networking environments, including Universal Mobile Telecommunication System (UMTS), Personal Communications Services (PCS), other circuit-switched and packet-switched technologies, 3G technologies, and beyond.

Referring to FIG. 1, the mobile terminal 102 communicates with the base transceiver station (BTS) 104 via an air interface. The BTS 104 is a component of the wireless network access infrastructure that terminates the air interface over which subscriber traffic is communicated to and from the mobile terminal 102. The Base Station Controller (BSC) 106 is a switching module that provides, among other features, handoff functions, and controls power levels in each BTS 104. The BSC 106 controls the interface between a Mobile Switching Center (MSC) (not shown) and BTS 104 in a GSM wireless network 108, and thus controls one or more BTSs in the call set-up functions, signaling, and in the use of radio channels. The BSC 106 also controls the interface between the Serving GPRS Support Node (SGSN) 110 and the BTS 104 in a GPRS network 112.

The Serving GPRS Support Node (SGSN) 110 serves GPRS mobile by sending or receiving packets via a Base Station Subsystem (BSS), and more particularly via the BSC 106 in the context of GSM systems. The SGSN 110 is responsible for the delivery of data packets to and from the mobile terminals 102 within its service area, and performs packet routing and transfer, mobility management, logical link management, authentication, charging functions, etc. In the exemplary GPRS embodiment shown in FIG. 1, the location register of the SGSN 110 stores location information such as the current cell and Visiting Location Register (VLR) associated with the terminal 102, as well as user profiles such as the International Mobile Subscriber Identity Number (IMSI) of all GPRS users registered with this SGSN 110.

The SGSN 110 may also connect to a Signaling System 7 (SS7) network 114, which is a system on the Public Switched Telephone Network (PSTN) that performs out-of-band signaling in support of the call establishment, billing, routing, and information exchange functions of the PSTN. The SS7 network 114 communicates with network elements such as an Authentication Center (AuC), Home Location Register (HLR), Equipment Identity Register (EIR), etc., collectively shown at block 116. The network 108 may include other network elements, such as a Lawful Interception Gateway (LIG) 118 that allows authorities to intercept GPRS mobile data calls, and a Charging Gateway (CG) 120 that serves as an intermediary with various Operations Support Systems (OSS) elements such as charging and billing systems 122.

An SGSN 110 is ultimately coupled to a Short Message Service Center (SMSC) 123 and/or Multimedia Message Service Center (MMSC) 124 to support SMS and MMS messaging respectively. While GSM forms the underlying technology, the SGSN 110 described above is a network element introduced through GPRS technology. Another network element introduced in the GPRS context is the Gateway GPRS Support Node (GGSN) 126, which acts as a gateway between the GPRS network 112 and a packet switched public data network, such as network 128. This gateway 126 allows mobile subscribers to access the public data network 128, specified private IP networks, or other wireline networks. The connection between the GGSN 126 and the public data network 128 is generally enabled through a standard protocol, such as the Internet Protocol (IP), and further may be coupled through a WAP gateway 130, the MMSC 124, and the like.

Multiple data networks may be connected through various GGSNs to provide service access to mobile terminals 102. Mobile terminal 102 may also support other air interfaces, such as a Bluetooth interface, to enable short range radio communication between the mobile terminal and, for example, Bluetooth access point 134. Bluetooth access point 134 may, for example, supply configuration and provision information to initially configure mobile terminal 102 for operation. Services themselves may also be provided via the Bluetooth access point 134, when the mobile terminal is within the appropriate range of the access point 134. Therefore, a formidable task is presented to the user of mobile terminal 102 in order to discover the various services available via local access points 134, and via network servers 133 or other systems that are hosted by service/content providers 132 using SMS, MMS, WAP, or other network technologies available to the mobile user. Access to the many services and applications offered by way of such a mobile communications has typically been facilitated through browsing and messaging capabilities of contemporary mobile devices, where a significant number of key presses may be required to locate and gain access to the desired services and applications. The service being offered may also have specific time constraints that specify when a particular service is valid, the type of service being offered, the price of the service, etc. This may further increase the complexity of service location and invocation.

FIG. 2 illustrates a front panel display 204 of an exemplary service panel as may be presented to an end user of mobile terminal 202. Icons 206-216 represent a Graphical User Interface (GUI) of mobile terminal 202, which allows the user to select features operable on the mobile terminal 202. Any number of different mobile terminal options may be available to the user. FIG. 2 illustrates some representative features including the Call Log 206, Retrieve Messages 208, Settings 210, Service Panel 212, Security Options 214, and Memory Functions 216. Call Log 206, for example, may allow a user to retrieve a list of all Calling Party Numbers (CgPN) incident to the mobile terminal. Retrieve Messages 208 may allow the user to retrieve voice messages left by the calling parties, while Settings 210 would allow a personalization of some of the functions of the mobile terminal, such as ringer volume, ringer type, etc. Selectable features 206, 208, 210, 214, and 216 represent resident applications or features that may be available on a mobile terminal, and these particular features depicted in FIG. 2 are illustrated to provide a representative sample of the types of selectable features that may be available via a GUI on a mobile terminal.

The Service Panel icon 212 represents the service panel feature in accordance with the present invention. Invocation of Service Panel 212 presents a list or other selectable group of services to the end user, which may include context-sensitive services dependent on the end user's location, time of day, etc.

Activation of service panel icon 212 results in the instantiation of the service panel 312, an example of which is illustrated in FIG. 3. Icons 304-310 correspond to representative services offered via service panel 302. Selection of music store icon 304, for example, represents a service that when invoked would access a music service to provide, for example, the top musical hits in several different musical categories. Selection of locator icon 306, for example, facilitates the location of friends, family members, colleagues etc. Selection of the weather icon 308 causes weather information to be presented to the end user, via front panel display 204 of mobile terminal 202 as illustrated in FIG. 2, or via other means such as audio. Icon 310 may be selected to initiate a service to allow the user access to current events, such as news services, or local events or services within a certain proximity of the user.

The services offered via the service panel 302 can also extend to physical devices, so that communication with the physical device can be initiated similarly to the manner in which communication is effected with locally-provided or network services. Communication protocols may differ for different devices, and the service panel in accordance with the present invention may be provisioned to appropriately communicate with each device. In this manner, the mobile terminal user can access physical devices by way of service panel 312 of the mobile terminal.

An example of such a physical device includes a set-top box, which generally allows analog/digital devices such as television sets to receive digital signals by way of, for example, digital satellite, digital terrestrial, and digital cable technologies. Other types of set-top boxes allow digital content to be transmitted from a mobile terminal to the set-top box for viewing on the television. For example, a mobile terminal having imaging or video capabilities, e.g., a digital camera or video recorder, can send images and/or video to the set-top box to allow the content to be presented via the television. Short-range transmission technologies such as Bluetooth can be used to facilitate the transmission between the mobile terminal and the set-top box. Games, songs, or other content available on the mobile terminal can likewise use the set-top box for presentation via the analog/digital television set.

Service panel 312 of FIG. 3 may include physical device icon 314 to represent physical devices, such as the set-top box as described above. In one embodiment of the invention, icon 314 represents a context sensitive device that would be active when both the mobile terminal and the set-top box are within the same Bluetooth hot spot as illustrated by FIG. 1. The set-top box may be provisioned to the service panel 312 in any desired manner. In one embodiment where Bluetooth technology is employed, the set-top box is provisioned to service panel 312 in connection with the pairing process that creates a link key and exchanges the link key between the mobile terminal and the set-top box. At this time, other information can be exchanged such as applications and/or Java midlets that provide a user interface for controlling the set-top box functions via the mobile terminal.

The attributes of each service that is provisioned for use on the mobile terminal may include, for example, a graphical icon that allows the service to be represented in a graphical mode with optional animation, or may simply include a single textual description. The attributes for the services may include descriptions of the services to allow the end user to ascertain the nature of operation of the particular service of interest. There may be several descriptions from which to choose, depending on the mobile terminal capabilities. For example, a script or software program (e.g. Java) may be executed when the service is invoked, or a URL or other network address may be provided to guide the user to a particular location that hosts the service. Still other examples include supplying a Mobile Subscriber Integrated Services Digital Network (MSISDN) number to be called when the service is invoked, or the use of SMS/MMS/email messages sent to a certain address when the service is invoked.

The set of services presented via the service panel may be context specific, meaning for instance, that the services displayed or otherwise presented may depend upon parameters such as the time of day that the service is requested, the location of the user, or a profile state that the user has selected for himself at the terminal. The profile selected may, for example, state that the current disposition of the end user is in a meeting, in the office, at home, etc. and may therefore determine which services are to be “screened” during those times. In another example, the user's location may dictate one or more services available via the service panel. For example, where the user is located in a particular city, city-specific services may be made available to the user via the service panel.

It should be noted that although front panel display 204 and service panel 312 are described in the context of an icon-based graphical user interface (GUI), any user interface may be implemented in accordance with the present invention. For example, the user interface that may range from simple textual displays to large color displays. Selection of the data items on the front panel display 204 and service panel 312 may be effected using a pointing device, such as a mouse pointer, joystick, trackball or other scrolling selector or cursor manipulating mechanism. The user interface may also include a touch screen interface where a stylus or the person's finger may be used to select items. Alternatively, user interfaces other than visual interfaces may be employed, such as voice commands. The present invention is applicable with any known or future mobile terminal user interface mechanism.

One advantage of providing a common place for invoking services by way of the service panel is that, although it provides a dynamic menu in the sense that service icons may be added or removed depending on the particular context, the user interface has the same look and feel as the device user interface. Therefore, any of the services available through the service panel can be selected via a standard interface, rather than having to first open a particular application (e.g., SMS client, MMS client, etc.) to access the service in the first place. The appropriate application will be launched using the appropriate communication technology. More particularly, in accordance with one embodiment of the present invention, selection of a service via the service panel will resolve what is the optimal way to invoke the service, such as via a voice call, WAP request, Java application, etc. This decision is based on, for example, what options were provided when the service was provisioned, and what the device/network capabilities are.

FIG. 4 illustrates an exemplary block diagram of a mechanism used to create a content download request 400 upon invocation of one of the representative service icons illustrated in FIG. 3. Identifier 401 is used to identify the particular service requested by the end user as requested from the service panel 312 of FIG. 3. As previously indicated, invoking a service may result in starting an existing application (e.g., a Java application) in the terminal, or may initiate a content download. A request may be initiated to download content over SMS, MMS, WAP, HTTP, Email, Bluetooth, IM, or other protocols. Therefore, the service panel may automatically invoke the appropriate application on the mobile terminal to effect the content download. The download request may be facilitated, for example, by SMS Application 406, MMS Application 408, WAP Application 410, HTTP Application 414, Email Application 416, Bluetooth Application 418, IM Application 420, etc. Java application 412 represents a Java application that may already be resident within mobile terminal 202 of FIG. 2, in which case, the service may be fulfilled by local Java application 412. Alternatively, the Java application may be downloaded as bytecode, such as in the case of a Java Midlet. While Java is referenced here, the present invention is equally applicable to other platform-independent programming technologies.

The content received from any one of the download requests depicted in FIG. 4 may be text, WML (Wireless Markup Language), XHTML (Extensible Hypertext Markup Language), ECMAScript, Java, etc. Voice calls may also be performed. Further, the request itself may be communicated via a number of technologies, such as a Personal Area Network (PAN, e.g., Bluetooth), Local Area Network (LAN), Wide Area Network (WAN, e.g., GSM, WCDMA, UMTS, etc.).

A content download request may also implement the Smart Messaging architecture, which may be facilitated via a network such as that illustrated in FIG. 1 with regard to the SMS service and the SMS Application 406 as illustrated in FIG. 4. The Smart Message architecture was first developed by the Narrow-Band Socket (NBS) protocol, which has since been adopted by the WAP forum's Wireless Datagram Protocol (WAP_WDP). In practice, the WDP does not deviate far from the NBS protocol and the protocol layer of the WAP stack, which resides within SMS Application 406, and is capable of handling Smart Message payloads. The Smart Message architecture allows the use of an extensible number of message formats. The message set enables a rich set of applications to be built on an Over-the-Air (OTA) environment, allowing for sending or receiving business cards, sending or receiving Internet Access Configuration related information, sending or receiving calendar related items, sending and receiving ringing tones and graphical information, and sending and receiving multipart messages.

Several configuration parameters may be accessed via the Smart Message architecture and stored in the service parameter storage 424. Exemplary parameters required for each service may include service name and the related service icon. A service pointer, whether it be a URL or a file descriptor, and a list of allowed bearers for the service (e.g. GPRS, Bluetooth, etc.) including bearer priority may be stored. Other parameters may include the GSM location area or Bluetooth service area where the service is accessible or relevant, service validity period, service access point settings, short service description, operator ID or service provider ID, service type, and service price. Once the service parameters are known, selection of the service from service panel 312 of FIG. 3 by the end user initiates an automatic instantiation of the service to the end user because all of the required network connection configuration data is already known and provided by service parameter storage 424.

FIG. 5 illustrates an exemplary block diagram of representative mechanisms that may be used to provision mobile terminal 508 with a list of services that may be offered by service providers. The provisioning mechanisms include static, remote, and local provisioning techniques. The static provisioning mechanism includes configuring mobile terminal 508 through factory settings, or though the use of SIM card 502 or other removable memory cards. The end user, for example, may possess one or more SIM cards that would conceivably enable the end user to configure mobile terminal 508 for a number of operational scenarios, which would involve a multitude of service provisioning configurations.

Remote provisioning of mobile terminal 508 may also be implemented through the use of remote techniques using a device management mechanism, e.g., SyncML protocol, in combination with mobile network 506. SyncML was designed to synchronize networked data with any mobile device and to synchronize any mobile device to networked data. The SyncML representation protocol is defined by a set of well-defined messages, XML (Extensible Markup Language) documents or MIME (Multipurpose Internet Mail Extensions), that are shared between synchronizing devices. SyncML supports data synchronization models that are based upon a request/response command structure, or those based upon a “blind push” structure. The SyncML representation protocol specifies what the result of various synchronization operations should be, based upon a synchronization framework and format that accommodates different data synchronization models. Remote provisioning can also be accomplished using other Wide Area Networks (WAN), such as SMS, MMS, etc.

Local provisioning of mobile terminal 508 may be accomplished through proximity/service discovery mechanisms, such as via Bluetooth 504. Bluetooth is a cable replacement technology based on short range radio links, which uses fast acknowledgment and frequency hopping to make the radio links robust. Bluetooth utilizes the Service Discovery Protocol (SDP) to discover which services are available through the use of Bluetooth devices and also allows discovery of the characteristics of the available services. Other short-range or Personal Area Network (PAN) technologies may also be employed, such as the Object Exchange (OBEX) protocol and others.

Local provisioning of mobile terminal 508 may also be accomplished using radio frequency identification (RFID) technology, which generally involves electromagnetic/electrostatic coupling in the radio frequency portion of the electromagnetic spectrum. For example, mobile terminal 508 may be equipped with an RFID reader, and transponder or “tag” 518 is activated by radio frequency waves emitted by the mobile terminal. When activated, the tag transmits information to the RFID reader of the mobile terminal 508 to supply provisioning and/or configuration information.

Through these and other provisioning mechanisms, new services may be added, changed or removed from parameter storage 510 either automatically or manually. Parameter storage 510 provides memory for network configuration attributes necessary for the services, as well as any other description attributes that may be necessary. Context filter 514 is coupled to parameter storage 510 and provisioning processor 512 in order to filter those services that either are not active or that must change their execution state based on, for example, location of mobile terminal 508, time of day, etc. Service panel 516 then allows the service characteristics to be displayed to the end user once filtered by context filter 514.

Provisioning messages, whatever the provisioning mechanism employed, may include a variety of different parameters. These parameters can include a service name, service icon or other indicia, and a service pointer such as a URL or file descriptor. The provisioning message may include an indication of the allowed bearers for the particular service, such as whether the bearer is GPRS, Bluetooth/PAN, WLAN, etc., including the bearer priority and/or other bearer settings. The message may include the GSM location area or Bluetooth service area, for example, where the service is accessible or relevant. A service validity period, service access point settings, a short service description, the operator/service provider ID, service type and/or price are other examples of what may be provided via the provisioning message. Further, the provisioning message may include an application, such as a Java application.

In one particular embodiment, the network operator and service providers can set up local service broadcasters that add new services to end users service panels over Bluetooth. Services can be automatically provisioned when an end user enters the service broadcaster coverage area. For example, in the case of Bluetooth, the radius of the cell may be anywhere between ten to one hundred meters. The service broadcaster may utilize Bluetooth OBEX profile to transfer the service information to the service panel of the terminal. The service broadcaster may be implemented, for example, as a Bluetooth service point having a GPRS back channel. Memory/storage requirements of the service broadcaster may be fulfilled using, for example, a flash memory, hard disk, or other storage device.

FIG. 6 is a flow diagram of service panel operation according to one embodiment of the present invention. Block 602 represents the provisioning of the mobile terminal, such as those discussed above. Once the services have been provisioned within the mobile terminal, they are ready for potential instantiation, according to their context in one embodiment of the invention. The number of services available to the mobile terminal, in other words, may be limited as to the location of the mobile terminal, the time of day, or any user profile state that may have been set upon configuration of the mobile terminal.

An exemplary context-dependent service may include a service offered by a service provider that provides a report on the expected weather conditions for a particular area, as exemplified by weather icon 308 of FIG. 3. In this instance, the position of the mobile terminal is paramount in determining the geographically-based weather report that is specific to the current location of the end user, and thus presents icon 308 as displayed by service panel 312 of FIG. 3. Icon 308 may, for example, display “Chicago Weather” or “Los Angeles Meteorological Conditions” depending on whether the mobile terminal is in the mid-west or west coast regions of the United States, respectively. Additionally, a time of day report to an end user via a service provider is necessarily dependent upon the end user's geographical position in order to provide the correct time for the particular time zone in which the end user happens to be located. Further, services may be presented directly based on the time of day, such as providing certain services during standard business hours.

In one embodiment of the invention, the user can partially or completely override the context-based changes to the service panel. For example, the user can bookmark certain services to the service panel so that they are not changed until the bookmark is removed. For example, if the context is location, and the user is within a certain distance from home (e.g., within 50 miles, 100 miles, etc.), the service to calculate time in different time zones may generally be presented. However, the user can override this by bookmarking the service to remain available via the service panel, regardless of where the user is currently located with the mobile terminal.

When the user has selected the services panel for viewing in step 604, all valid services at the time of selection are rendered in step 606 and displayed to the end user. As discussed above, the display may be graphically based as illustrated in FIG. 3, a textual listing of all available services, audio, or other format. Once the active services have been displayed, and the user has selected a service from the service panel as determined at decision block 608, the service is executed 610.

Significant advantages are realized by the present invention relating to both the end user and the service provider. In particular, the end user is no longer plagued with the daunting task of navigating the network to locate the many services offered via the network. Further, the services are not hidden behind the various applications on the mobile terminal that are dedicated to certain access mechanisms. Rather, the end user terminal is provisioned with the various services and/or applications offered by service providers via the network, and through the use of the service panel, is able to select from any number of provisioned services that automatically utilize the appropriate access mechanism. Thus, determination of which service provider to use for a selected service has already been optimized by the service panel application. The services offered by the service panel may be filtered by a context filter, which only allows the display of those services that are “operable” given such parameters as the end user's location, time of day, or personal profile.

Additionally, the service providers are allowed a single mode of provisioning their services to end users, despite the particular hardware or software configuration of the respective mobile terminals. Scalability across different terminal user interface categories, across different service technologies and across different bearer technologies, both local (e.g. Bluetooth) and remote (e.g. cellular network).

The mobile terminals described in connection with the present invention may be any number of wireless devices incorporating user profile information, such as wireless/cellular telephones, personal digital assistants (PDAs), or other wireless handsets, as well as portable computing devices capable of wireless communication. The mobile terminals utilize computing systems to control and manage the conventional device activity as well as the functionality provided by the present invention. Hardware, firmware, software or a combination thereof may be used to perform the various functions, display presentations and operations described herein. An example of a representative mobile terminal computing system capable of carrying out operations in accordance with the invention is illustrated in FIG. 7.

The exemplary mobile computing arrangement 700 suitable for performing the operations in accordance with the present invention includes a processing/control unit 702, such as a microprocessor, reduced instruction set computer (RISC), or other central processing module. The processing unit 702 need not be a single device, and may include one or more processors. For example, the processing unit may include a master processor and associated slave processors coupled to communicate with the master processor.

The processing unit 702 controls the basic functions of the mobile terminal as dictated by programs available in the program storage/memory. Thus, the processing unit 702 executes the functions associated with the service panel of the present invention. More particularly, the program storage/memory 704 may include an operating system and program modules for carrying out functions and applications on the mobile terminal. For example, the program storage may include one or more of read-only memory (ROM), flash ROM, programmable and/or erasable ROM, random access memory (RAM), subscriber interface module (SIM), wireless interface module (WIM), smart card, or other removable memory device, etc. The service panel modules associated with the present invention, such as the service panel application 706 and local applications 708 (e.g., resident Java application) that may be identified by application identifiers and invoked, may also be transmitted to the mobile computing arrangement 700 via data signals, such as being downloaded electronically via a network, such as the Internet and intermediary wireless networks.

The processor 702 is also coupled to user-interface 710 elements associated with the mobile terminal. The user-interface 710 of the mobile terminal may include, for example, a display 712 such as a liquid crystal display, a keypad 714, speaker 716, and microphone 718. These and other user-interface components are coupled to the processor 702 as is known in the art. The keypad 714 includes alpha-numeric keys for performing a variety of functions, including dialing numbers and executing operations assigned to one or more keys. For example, in accordance with the present invention, various functions associated with the network communications may be initiated and/or carried out by using the keypad 714. Alternatively, other user-interface mechanisms may be employed, such as voice commands, switches, touch pad/screen, graphical user interface using a pointing device, trackball, joystick, or any other user interface mechanism.

The mobile computing arrangement 700 may also include a digital signal processor (DSP) 720. The DSP 720 may perform a variety of functions, including analog-to-digital (A/D) conversion, digital-to-analog (D/A) conversion, speech coding/decoding, encryption/decryption, error detection and correction, bit stream translation, filtering, etc. The transceiver 722, generally coupled to an antenna 724, transmits and receives the radio signals 726 between the wireless device and the network. Other transceivers may be employed, depending on the technologies employed by the mobile computing arrangement 700. For example, a separate transceiver may be utilized to communicate via Bluetooth, or other technology.

The storage/memory 704 may be used to store the service panel application 706. Local applications 708 may be stored on the storage/memory 704, such as resident Java applications, downloaded Midlets, WAP browsers, etc. A Java Virtual Machine (JVM) 710, typically implemented in software, may also be stored in the storage/memory 704 to process Java bytecode if the service selected through the service panel is configured to access such bytecode. The program storage/memory 704 may also be used to store data 712, such as the content provided by a service provider concerning an offered service. In one embodiment of the invention, the content is stored in non-volatile electrically-erasable, programmable ROM (EEPROM), flash ROM, etc. so that the content is not lost upon power down of the mobile terminal. In other embodiments, data may be stored in volatile memory, as the data may be transitory and of little use at a later date.

The mobile computing arrangement 700 of FIG. 7 is provided as a representative example of a computing environment in which the principles of the present invention may be applied. From the description provided herein, those skilled in the art will appreciate that the present invention is equally applicable in a variety of other currently known and future mobile computing environments. For example, the service panel modules in accordance with the present invention may be stored in a variety of manners, may be operable on a variety of processing devices, and may be operable in mobile devices having additional, fewer, or different supporting circuitry and user-interface mechanisms.

Using the description provided herein, the invention may be implemented as a machine, process, or article of manufacture by using standard programming and/or engineering techniques to produce programming software, firmware, hardware or any combination thereof. Any resulting program(s), having computer-readable program code, may be embodied on one or more computer-usable media such as resident memory devices, smart cards or other removable memory devices, or transmitting devices, thereby making a computer program product or article of manufacture according to the invention.

As indicated above, memory/storage devices include, but are not limited to, disks, optical disks, removable memory devices such as smart cards, SIMs, WIMs, semiconductor memories such as RAM, ROM, PROMS, etc. Transmitting mediums include, but are not limited to, transmissions via wireless/radio wave communication networks, the Internet, intranets, telephone/modem-based network communication, hard-wired/cabled communication network, satellite communication, and other stationary or mobile network systems/communication links.

From the description provided herein, those skilled in the art are readily able to combine software created as described with appropriate general purpose or special purpose computer hardware to create a mobile computer system and/or computer subcomponents embodying the invention, and to create a mobile computer system and/or computer subcomponents for carrying out the method of the invention.

The foregoing description of the exemplary embodiment of the invention has been presented for the purposes of illustration and description. It is not intended to be exhaustive or to limit the invention to the precise form disclosed. Many modifications and variations are possible in light of the above teaching. For example, it will be apparent to those skilled in the art from the foregoing description that the invention is equally applicable to other current or future provisioning mechanisms used to automatically or manually provision services within the mobile terminals. It is intended that the scope of the invention be limited not with this detailed description, but rather by the claims appended hereto.

What is claimed is:

1. A method of accessing services on a mobile terminal, comprising:
collectively presenting one or more selectable service items by the mobile terminal, each of the selectable service items corresponding to a service;
facilitating user selection of at least one of the service items;
activating one of a plurality of access applications associated with the selected service item; and
invoking the service associated with the selected service item using the activated access application.

2. The method of claim 1, wherein invoking the service comprises initiating a content download request.

3. The method of claim 2, wherein:
activating one of a plurality of access applications comprises activating one of an SMS, MMS, HTTP, e-mail, Bluetooth, and IM applications resident on the mobile terminal and associated with the selected service item; and
wherein initiating the content download request comprises initiating the content download request via the activated one of the SMS, MMS, HTTP, e-mail, Bluetooth, and IM applications.

4. The method of claim 1, further comprising associating one of the plurality of access applications with each of the selected service items

5. The method of claim 4, wherein associating one of the plurality of access applications with each of the selected service items comprises provisioning the service corresponding to each of the selected service items on the mobile terminal, and associating the selected service item with the access application corresponding to a network service access technology identified via the provisioning.

6. The method of claim 5, wherein activating one of a plurality of access applications comprises activating the access application corresponding to the network service access technology.

7. The method of claim 1, wherein collectively presenting one or more selectable service items by the mobile terminal comprises presenting the selectable service items via a graphical user interface.

8. The method of claim 1, wherein the services are provided via one or more of a wireless network, a wireline network, and a short-range wireless transmission technology.

9. A method of accessing services offered via a network at a mobile terminal, the method comprising:
provisioning services onto the mobile terminal;
activating a service panel to display selectable symbols corresponding to the provisioned services;
filtering the provisioned services based on a context of the mobile terminal, and displaying the selectable symbols corresponding to context sensitive services; and
activating the context sensitive services by selecting a corresponding one of the filtered selectable symbols from the service panel.

10. The method according to claim 9, wherein provisioning services onto the mobile terminal includes using a subscriber identity module (SIM).

11. The method according to claim 9, wherein provisioning services onto the mobile terminal includes using Bluetooth enabled devices.

12. The method according to claim 9, wherein provisioning services onto the mobile terminal includes using SyncML technology over a network.

13. The method according to claim 9, wherein provisioning services onto the mobile terminal includes using radio frequency identification (RFID) technology.

14. The method according to claim 9, wherein activating the service panel to display the provisioned services includes selecting a service panel entry from a display of the mobile terminal.

15. The method according to claim 14, wherein the display of the mobile terminal includes a graphical display of information.

16. The method according to claim 14, wherein the display of the mobile terminal includes a textual display of information.

17. The method according to claim 9, wherein activating the context sensitive service includes:
locating service parameters from service parameter storage; and
using the service parameters to automate location and instantiation of the service from the network.

18. A method for facilitating service execution by mobile terminals, the method comprising:
allocating a list of predetermined services to the mobile terminal;
filtering the predetermined list of services in response to a context of the mobile terminal;
activating a service panel to allow selection from the filtered list of predetermined services; and
launching the selected service by simply selecting from one of the services displayed by the service panel.

19. The method according to claim 18, wherein allocating the list of predetermined services to the mobile terminal includes using a subscriber identity module (SIM).

20. The method according to claim 18, wherein allocating the list of predetermined services to the mobile terminal includes using Bluetooth enabled devices.

21. The method according to claim 18, wherein allocating the list of predetermined services to the mobile terminal includes using SyncML technology.

22. The method according to claim 18, wherein activating the service panel to allow selection from the filtered list includes selecting a service panel entry from a display of the mobile terminal.

23. The method according to claim 22, wherein the display of the mobile terminal includes a graphical display of information.

24. The method according to claim 22, wherein the display of the mobile terminal includes a textual display of information.

25. A mobile terminal comprising:
a provisioning means for receiving a list of services available to the mobile terminal;
a storage means to store content associated with the services;
a filter means coupled to the storage means to limit the list of services based on a context; and
a service panel means coupled to the filter means to display the services based on the context.

26. The mobile terminal of claim 25, wherein the provisioning means is arranged to accept service configuration data from a subscriber identification module.

27. The mobile terminal of claim 25, wherein the provisioning means is arranged to accept service configuration data from a SyncML enabled device.

28. The mobile terminal of claim 25, wherein the provisioning means is arranged to accept service configuration data from a Bluetooth enabled device.

29. The mobile terminal of claim 25, wherein the filter means uses a time of day to filter services.

30. The mobile terminal of claim 25, wherein the filter means uses a position of the mobile terminal to filter services.

31. The mobile terminal of claim 25, wherein the service panel means includes a graphical display device.

32. The mobile terminal of claim 25, wherein the service panel means includes a textual display device.

33. A system for facilitating service provisioning by mobile terminals, comprising:
at least one provisioning device used to provide a list of services; and
a mobile terminal coupled to the at least one provisioning device, the mobile terminal comprising:
a provisioning means for receiving a list of services available to the mobile terminal from the at least one provisioning device;
a storage means to store content associated with the services;
a filter means coupled to the storage means to limit the list of services based on a context; and
a service panel means coupled to the filter means to display the services based on the context.
